(19) United States
(12) Patent Application Publication
(10) Pub. No.: US 2012/0158376 A1
(43) Pub. Date: Jun. 21, 2012

(54) FAULT ANALYSIS SYSTEM

(75) Inventors: Stephen Robert Freeman, Retford (GB); Simon David Harris, Burley in Wharfdale (GB); Rob John Knipe, Ilkely (GB)

(73) Assignee: ROCK DEFORMATION RESEARCH LIMITED, Leeds (GB)

(21) Appl. No.: 13/144,876

(22) PCT Filed: Jan. 15, 2010
(86) PCT No.: PCT/GB2010/000050

§ 371 Date: Mar. 2, 2012

Related U.S. Application Data
(60) Provisional application No. 61/156,631, filed on Mar. 2, 2009.

(30) Foreign Application Priority Data
Jan. 16, 2009 (GB) 0900687.5

(51) Int. Cl. G01V 1/30

(52) U.S. Cl. 703/2

(57) ABSTRACT

A fault seal analysis system with a data input which receives data pertaining to one or more physical parameters of a rock stratigraphy at or near a fault and means for analysing the data by applying one or more algorithm to create a model of the geometry and physical properties of the rock at or near the fault, the analysis means further comprising a user input which allows a user to vary input parameters of the one or more algorithms and creating one or more data volumes or models of the geometric and physical parameters. The analysed data is represented on a fault plane property viewer having at least one fault property diagram of a fault and a software module adapted to interrogate the data volume to map data from the data volume onto the diagram to show the sealing properties of the fault.

### TECHNICAL FIELD

The present invention relates to a fault analysis system for use in determining characteristics of geological faults, especially geological faults associated with fluid reservoirs such as hydrocarbon reservoirs.

### BACKGROUND

Geological faults associated with fluid reservoirs can act as a transmitter of or barrier to fluid flow and pressure communication by either holding hydrocarbons in, or providing a route through which they get out from the reservoir.

Sealing faults are a primary control on the trap in many hydrocarbon reservoirs, but can also transform a relatively large and continuous hydrocarbon reservoir into compartments that behave as a collection of smaller reservoirs.

A sealing fault can occur if a fault intersects different lithologies and places permeable reservoir quality rock against less permeable rock.

A fault seal may also form where the fault occurs within a single lithology and the rock forming the fault develops a lower permeability. The sealing properties of the rock are related to the conditions of deformation and lithologic factors such as clay content.

Faults that do not form a seal may prevent oil and gas from accumulating allowing them to migrate through structures in the subsurface. Open and permeable faults within an established reservoir can cause serious losses of circulation during drilling operations. The loss of drilling mud can be expensive and dangerous and can result in the abandonment of wells.

Therefore, describing the characteristics and behaviour of a fault is very important in hydrocarbon drilling, exploration and development.

One way of better understanding the behaviour of faults is Fault Seal Analysis. Current Fault Seal Analysis techniques utilize seismic data, structural and microstructural information from high resolution core analysis, wellbore and production data to predict fault behaviour and to reduce uncertainty and risk in faulted reservoir exploitation.

It is an object of the present invention to provide an improved fault analysis system.

### SUMMARY

In accordance with a first embodiment there is provided a fault seal analysis system comprising:

data input means adapted to receive data pertaining to one or more physical parameters of a rock stratigraphy at or near a fault;
analysis means adapted to
I. apply one or more algorithms to create a model of the geometry and physical properties of the rock at or near the fault, the analysis means further comprising a user input which allows a user to vary input parameters of the one or more algorithms; and
II. create one or more data volumes or models of the geometric and physical parameters; and
   a fault plane property viewer having at least one fault property diagram of a fault and a software module adapted to interrogate the data volume to map data from the data volume onto the diagram to show the sealing properties of the fault.

The system further may comprise control means for adapting input data to view the response to the sealing properties of the fault as shown on the fault property diagram.

The FPPV may be further adapted to allow the user to select from a plurality of data volumes.

For a given fault, for a known depth and throw variation over a fault surface a stratigraphy model can be chosen and each data volume that is generated is designed to capture a range of uncertainties in the different parameters and allow the user to interrogate these using a fault property diagram.

The selection may be made on the GUI.

The selection may be made by representing each data volume graphically and allowing the user to move between the graphical representations.

The data received at data input means may be well data.

Data received at data input means may comprise 1 dimensional well data or two dimensional panel data.

The panel may comprise data comprising a pre-defined lateral variation in well data, in other words a set of 1 dimensional wells stacked together.

The input data may comprise well log data such as Vshale or Vclay.

The input data may comprise data which identifies the reservoir units, top seal and trap geometry.

A first algorithm may be applied to model stratigraphic variation based upon the input data.

A second algorithm may be applied to create one or more pseudo well based upon input well data.

The system may further comprise a fault rock clay mixing calculation.

The clay mixing calculation may comprise a combination of one or more of shale gouge ratio (SGR), effective shale gouge ratio (ESGR) in foot wall (FW) and ESGR in hanging wall (HW).

The system may further comprise a clay smear calculation.

A third algorithm may calculate sealing capacity parameters.

The sealing capacity parameters may be calculated by using data related to threshold pressure, a threshold pressure function, fluid parameters and output statistics.

The sealing capacity parameters may be calculated by applying a predictive function that is based on the known variations in threshold pressure as a function of clay content.

The known values may be derived from historical changes in the physical conditions that the rock has experienced.

The historical data may relate to geohistory information, categorisation of rock evolution, range of temperature, temperature during faulting and pressure history.

The historical data can be presented as a series of curves of threshold pressure as a function of clay content.

The sealing capacity parameters may be calculated by calculating the match between user defined parameters and the known historical data.

The degree of matching may be presented graphically.

A bar graph may provide a measure of the degree of matching.

The user can select historical data that is not the best match.

Sealing capacity values may be calculated from the sealing capacity parameters in order to provide a range of results.

A parametric approach may be used in which input parameters can be varied and sealing capacity values are calculated for each combination of parameters.

A statistical approach may be used.

Monte Carlo statistical analysis may be used.

In accordance with a second embodiment there is provided a computer program comprising program instructions for implementing the system in accordance with the first aspect of the invention.

In accordance with a third embodiment there is provided a fault seal analysis system comprising:

data input means adapted to receive data pertaining to one or more physical parameters of a rock stratigraphy at or near a fault;
analysis means adapted to
I. apply one or more algorithm to create a model of the geometry and physical properties of the rock at or near the fault, the analysis means further comprising a user input which allows a user to vary input parameters of the one or more algorithm; and
II. create one or more data volumes or models of the geometric and physical parameters;
   a fault plane property viewer having at least one fault property diagram and a software module adapted to interrogate the data volume to map data from the data volume onto the diagram to show the sealing properties of the fault; and
   control means for adapting an input to a well in response to the sealing properties of the fault as shown on the diagram.

### BRIEF DESCRIPTION OF THE DRAWINGS

The present invention will now be described by way of example only with reference to the accompanying drawings in which:

FIG. 1 illustrates the general function of a system in accordance with an embodiment;

FIG. 2 is the GUI used to input well data in an embodiment;

FIG. 3a and FIG. 3b are the GUIs used when creating a stratigraphic architecture in an embodiment;

FIGS. 4a to 4d show the GUIs used when creating parent/child wells in an embodiment;

FIGS. 5a to 5d show the GUIs used when calculating sealing capacity parameters in an embodiment;

FIGS. 6a and 6b show the GUIs used when calculating sealing capacity in an embodiment;

FIG. 7 shows the GUI used when calibrating the FPPV and PRISM data volume;

FIGS. 8a and 8b show the GUIs of the input to the fault plane property viewer in an embodiment;

FIG. 9 shows the GUI of the input to the FPPV which allows variation in clay content, threshold pressure function and the fluid property parameter;

FIG. 10 shows the GUI which allows property filtering;

FIG. 11 shows an example of a property filter;

FIG. 12 shows the sealing capacity settings;

FIG. 13 shows the search path in graphical form;

FIG. 14 is the GUI which shows the manner in which stratigraphic scenarios may be selected in an embodiment;

FIG. 15 is a flow diagram which illustrates the operation of an embodiment of a fault analysis tool in accordance with an embodiment; and

FIG. 16 is a flow diagram which illustrates the operation of a second embodiment of a fault analysis tool in accordance with an embodiment.

### DETAILED DESCRIPTION

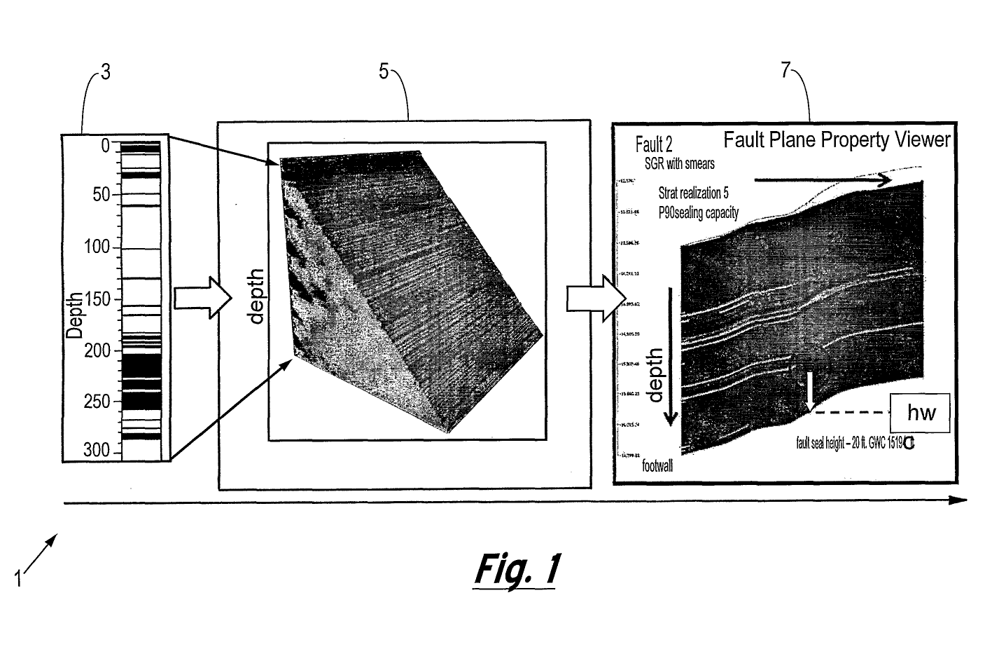

FIG. 1 shows an overview 1 of a system in accordance with an embodiment. Input data 3 from one or more wells is provided; this can include well log data such as Vshale and Vclay as well as data which identify the reservoir units, top seal and trap geometry. The data is processed 5 to create a data file that builds stratigraphic scenarios and calculates fault rock properties with defined uncertainties. The data volume is a prism which presents the data with respect to depth, throw and stratigraphic variation. A number of data volumes can be created by changing input variables and by applying different mathematical and statistical algorithms to the input data.

The fault plane property viewer 7 provides a physical mapping of the data volume across the geometry of the fault. In other words, the map of the actual fault is used to interrogate the data volume by defining data that corresponds with the physical location of the fault.

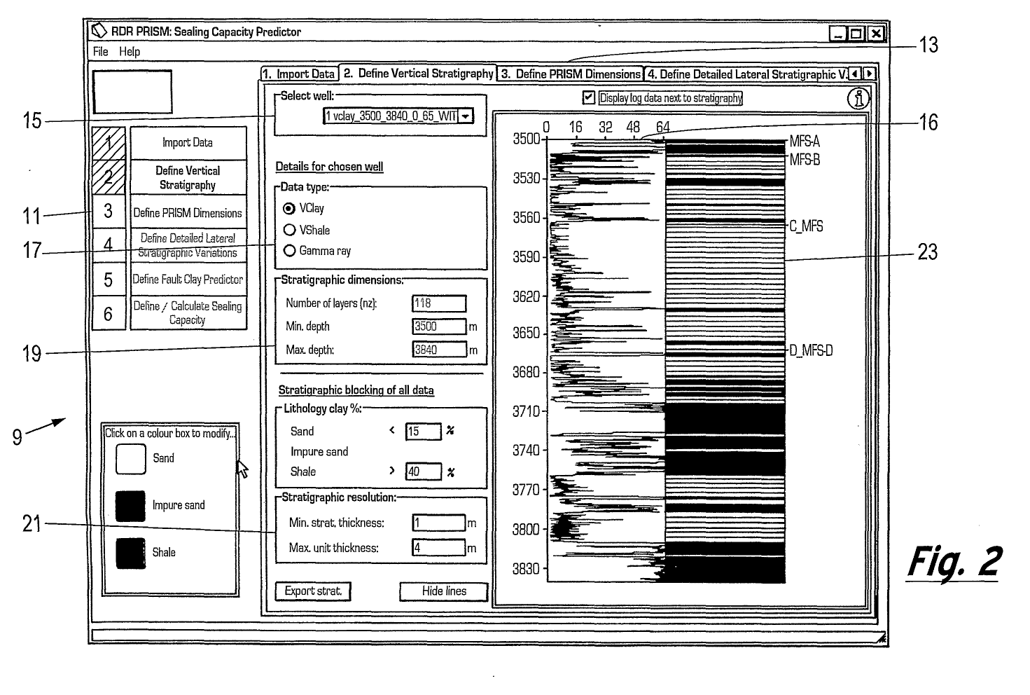

FIG. 2 shows the graphical user interface (GUI) of a system in accordance with an embodiment. The GUI 9 comprises a menu 11 which presents the user with information on the steps numbered 1 to 6 which are required to create a data volume. Access to different pages of the GUI to allow the user to input information in connection with each of the steps is provided by the tabs 13 arranged along the top of the page. The page of the GUI 9 as shown relates to the information required from the user to define the vertical stratigraphy. Well input data can be selected in field 15.

Once selected, the input data is presented as a graph 16 of depth against composition and a data type 17 for the chosen well is then defined.

The user is then able to define the stratigraphic dimensions such that the continuous input data is presented as discreet layers of user-defined thickness. The user can also define the manner in which the input data is categorised by the stratigraphic blocking of data 21 which allows the user to present each of the layers defined by the above-mentioned stratigraphic dimensions as been of, in this example, sand, impure sand or clay. This is achieved by allowing the user to select a minimum and maximum values of sand and impure sand in order to categorise the stratigraphies.

The user then defines the stratigraphic resolution which determines the thickness of the bars presented in graphic 23.

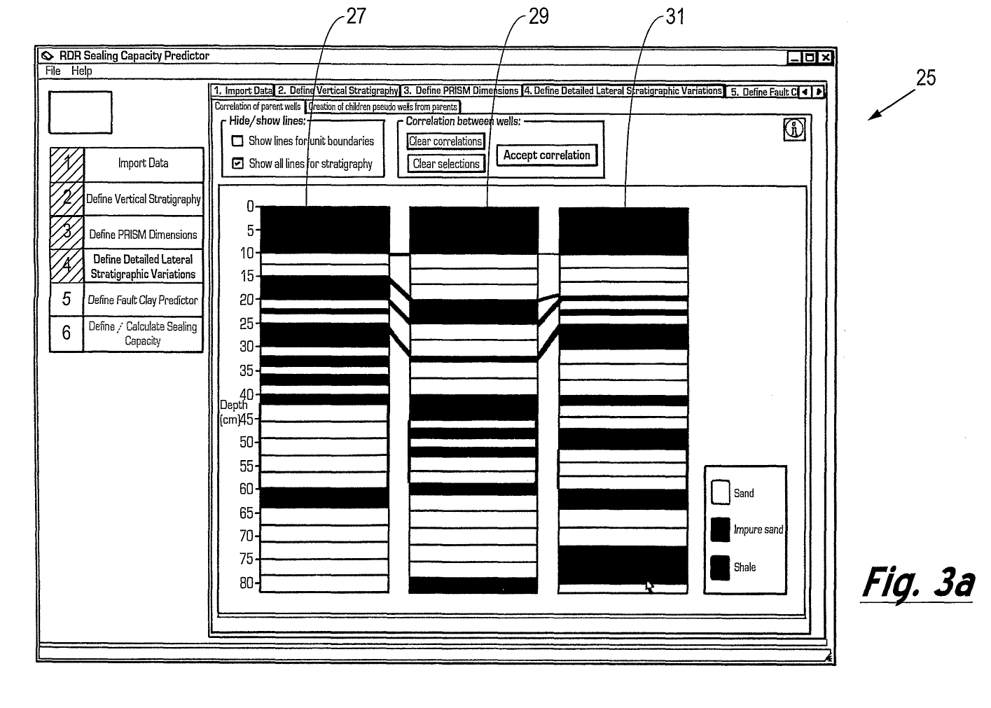

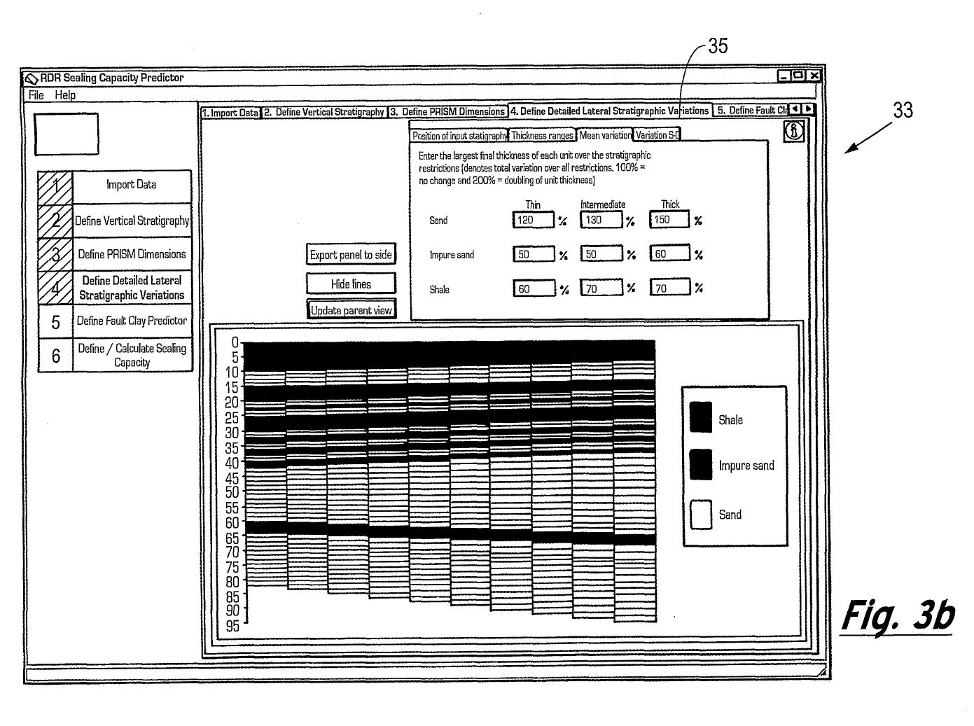

FIG. 3a shows the creation of the stratigraphic architecture. The GUI 25 contains bar graphs which show the depth and composition of wells 27, 29 and 31. The user is able to define the connections between different layers of the wells 27, 29 and 31 and to calculate the spatial stepwise change between the wells based upon that correlation as shown in FIG. 3b. Lateral variation is calculated by adding user-defined additional input variables such as position of input stratigraphy, thickness ranges and mean variation. A stepwise lateral variation from the well is calculated on the basis of the well data and these additional variables 35.

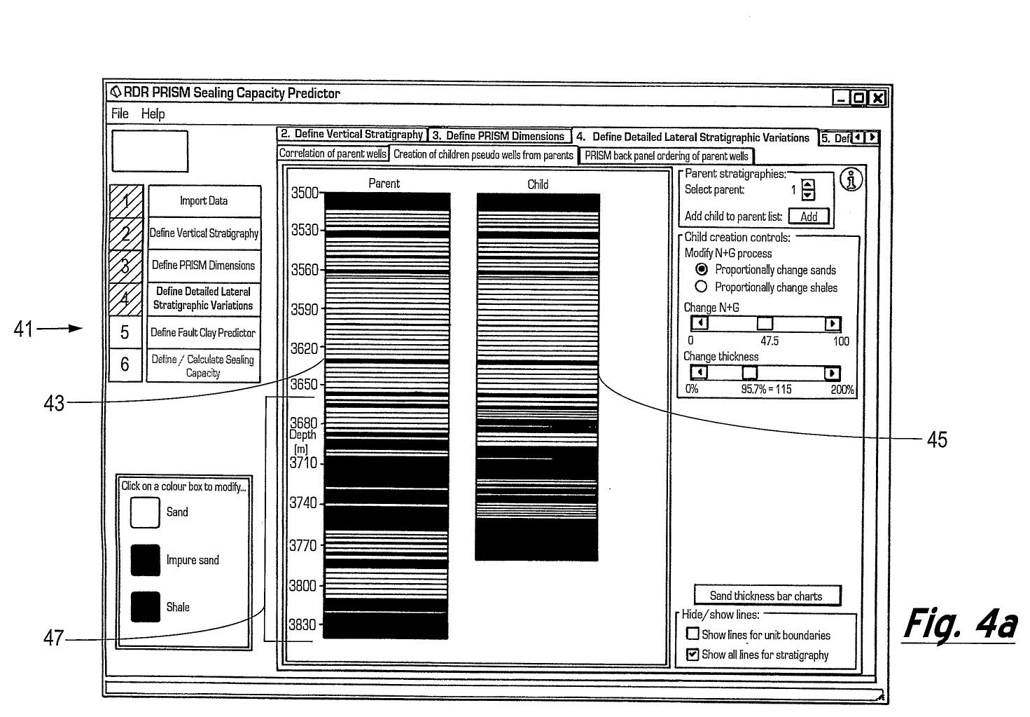

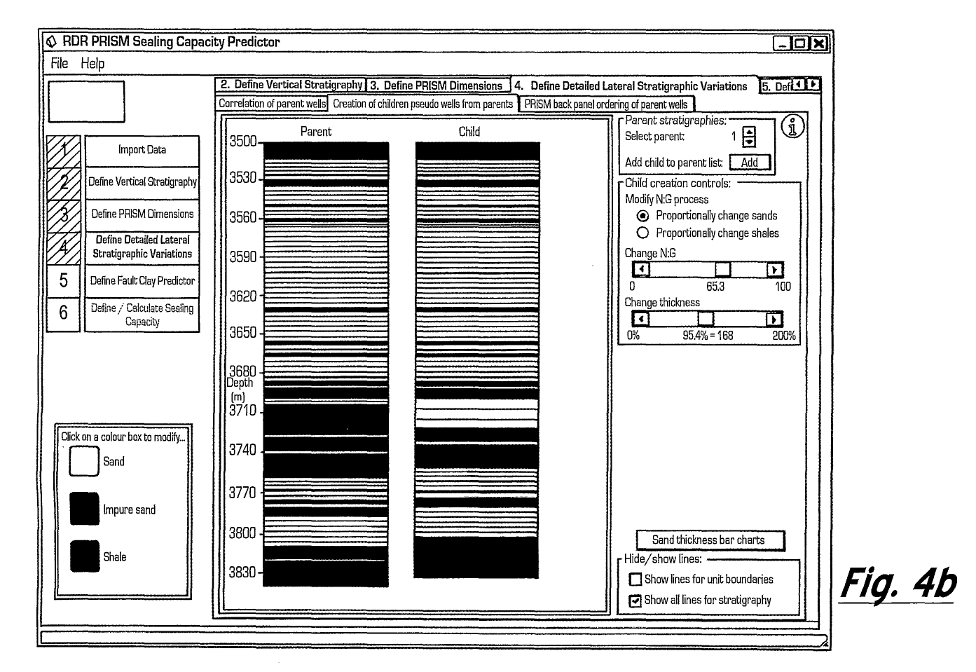

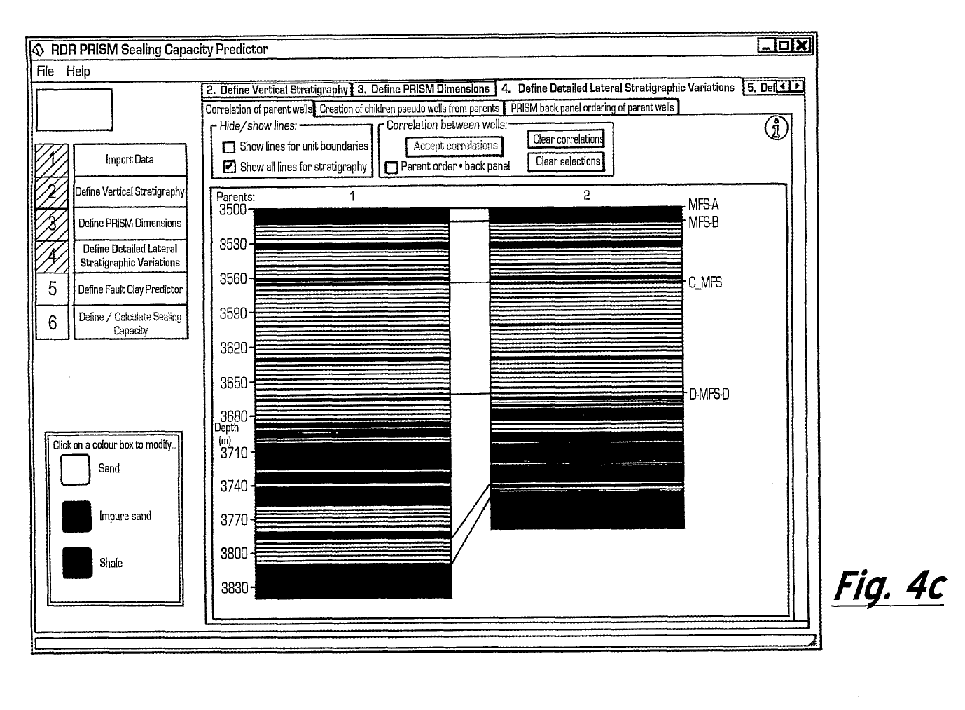

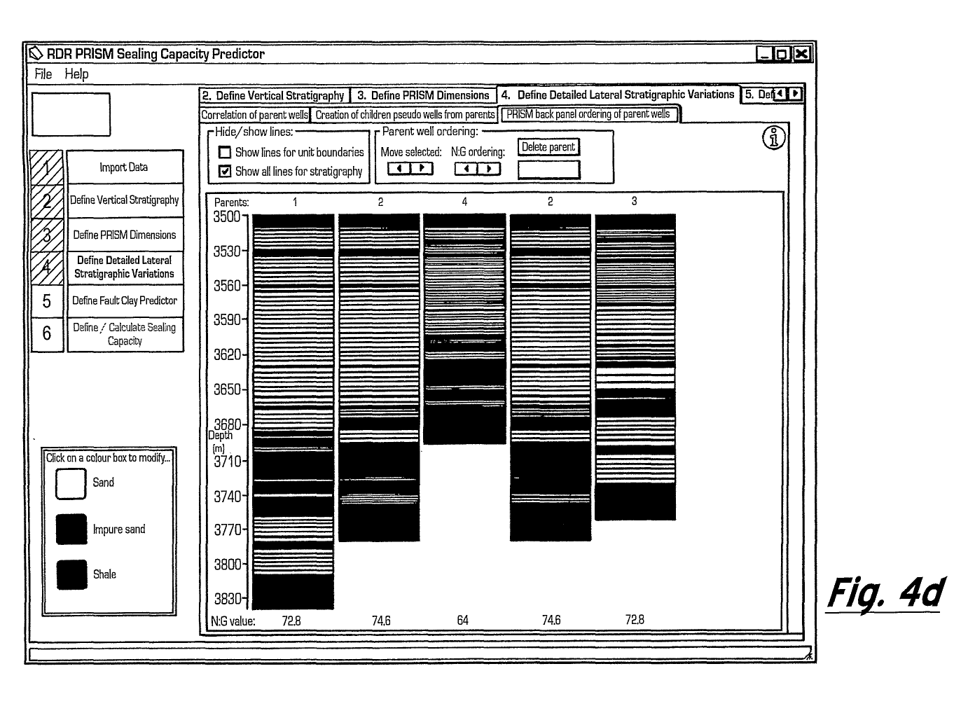

The system also allows the user to create what is termed ‘children pseudo wells’ from actual well data which are termed ‘parent wells’. This feature is shown in the GUI 41 FIG. 4. The parent well bar graph 43 is shown beside the child well bar graph 45. The child well is created by determining parameters which are allowed to vary such as variation in sand or shale content. The child was calculated using a subset of the present well data.

In addition, it is possible to examine the correlation between parent well data as shown in FIG. 4c. In this figure, layers in parents 1 and 2 are linked. FIG. 4d displays an arrangement of the chosen parent or child stratigraphies to form the back panel of the prism data volume.

The clay content is calculated using known algorithms to calculate clay mixing, such as shale gouge ratio (SGR), effective shale gouge ratio (ESGR) in the hanging wall or foot wall or clay smearing. The shale gouge ratio estimates the percentage of clay at any point in the fault zone from the mixing of the host lithology. The algorithm calculates the net clay within the lithology that is displaced past each point in the fault by taking the sum of the layer thickness multiplied by the clay percentage divided by fault throw. ESGR uses a weighted SGR that allows a non-uniform distribution of the clay within the section dragged past each point on the fault to model a more complex fault zone process. The present invention also allows the calculation of average, minimum and maximum combined ESGR values from the combined hanging wall and foot wall values.

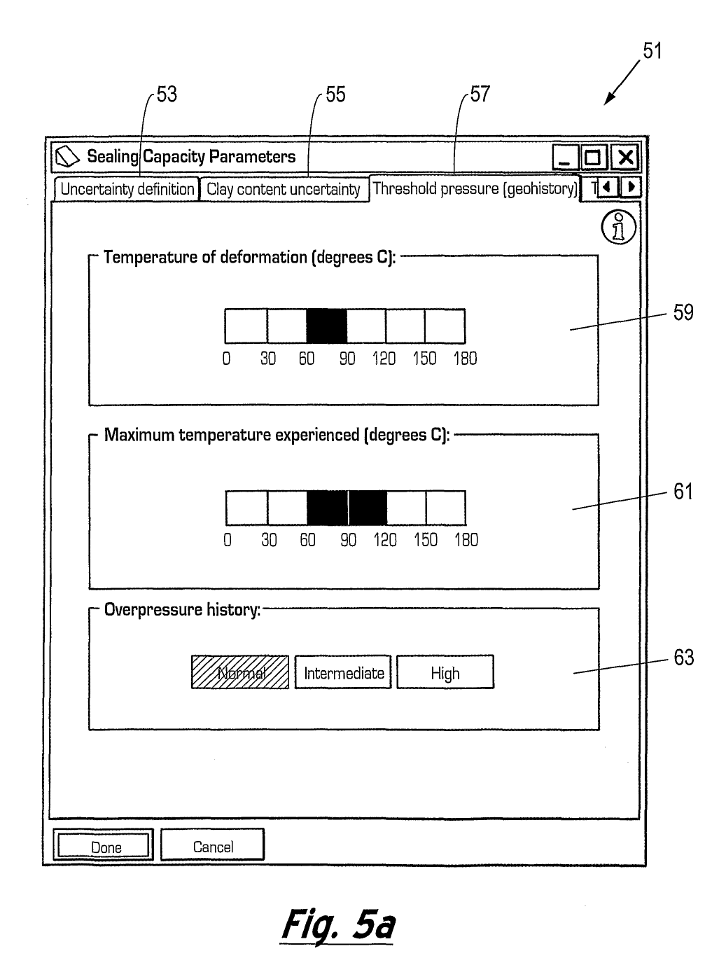

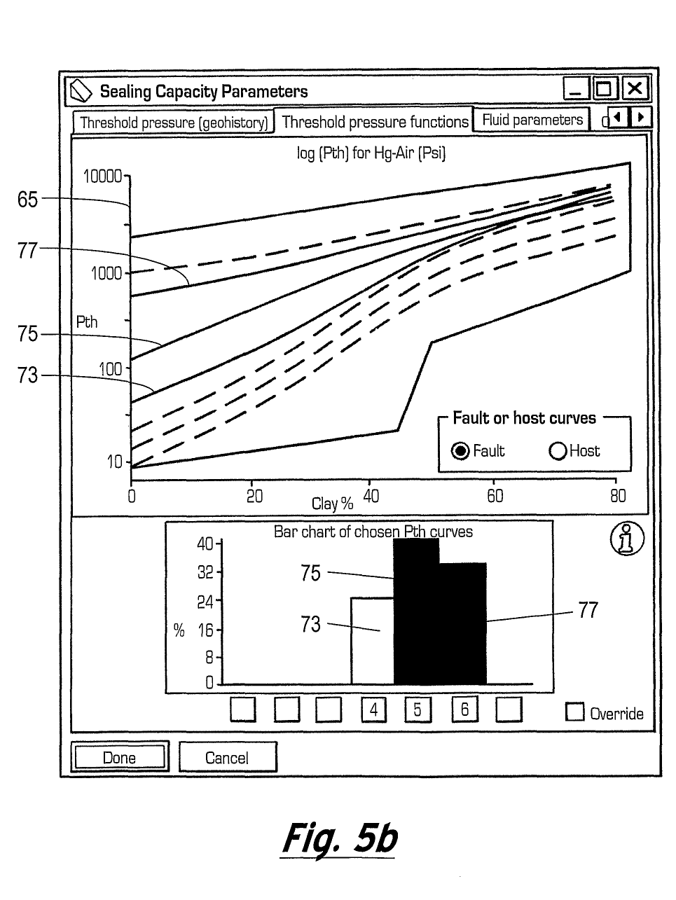

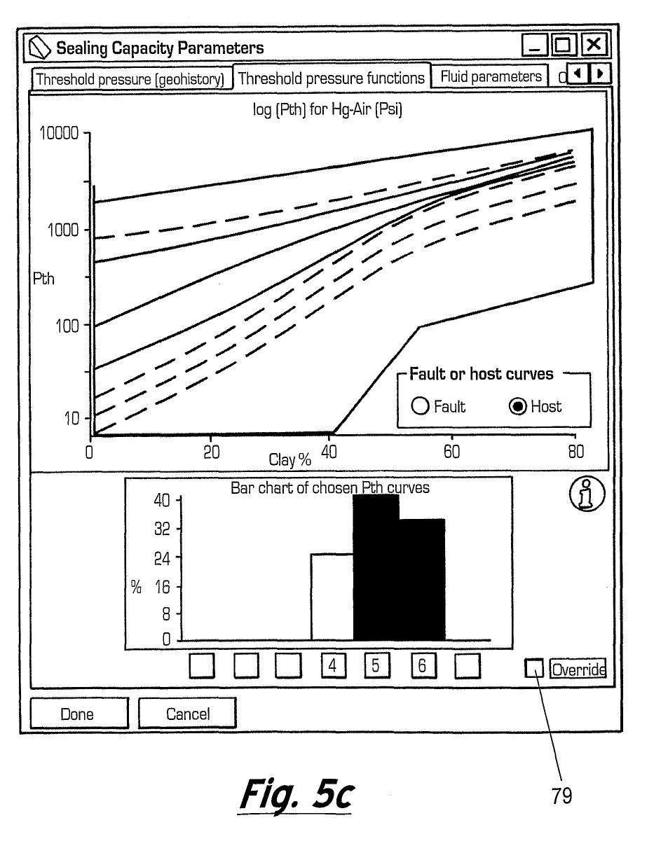

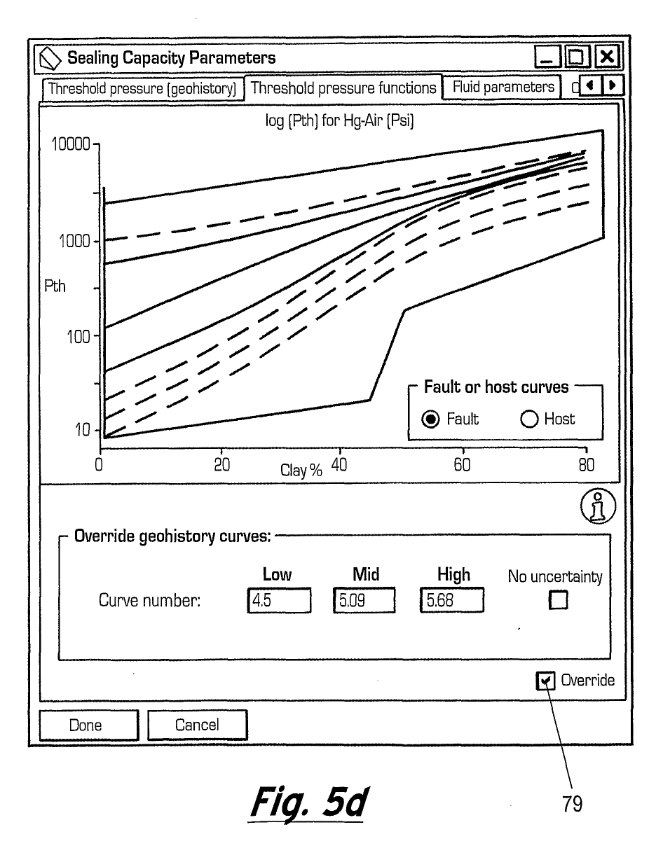

In calculating the sealing capacity parameters, the system also applies a predictive function that is based on the known variations in threshold pressure as a function of clay content. This feature of the invention is shown in FIGS. 5a to 5d. FIG. 5a is a GUI 51 which has six tabs labelled uncertainty definition 53, clay content uncertainty 55 and threshold pressure (geohistory) 57, threshold pressure functions, fluid parameters and output statistics. The content of the threshold pressure tab 57 is visible in FIG. 5a. This tab allows the user to set three parameters namely temperature of deformation 59, maximum temperature experienced 61 and overpressure history 63.

FIG. 5b shows a graph of capillary threshold pressure against percentage clay content for a set of fault curves. The curves shown in FIG. 5b are derived from collected data at a range of temperatures and for different overpressure histories. Once the user has chosen parameter values in FIG. 5a, the system of the present invention calculates which of the curves derived from the known data best fits the user-defined parameters. Bar graph 71 provides a measure of the extent to which the curves fit the data and ranks the curves; in this example only three curves fit the user defined parameters and they are given respective bars in the bar graph 71 and colour-coded to match the associated curves of graph 65. This is illustrated by corresponding reference numerals.

FIG. 5c is similar to FIG. 5b except that in this case, the graph of capillary threshold pressure against percentage clay content has been selected to be for a set of host curves. Both FIGS. 5b and 5c have an override 79 which allows the user to select a range of curves other than those fitting the user-defined parameters. The user-defined curves are shown in FIG. 5d 81.

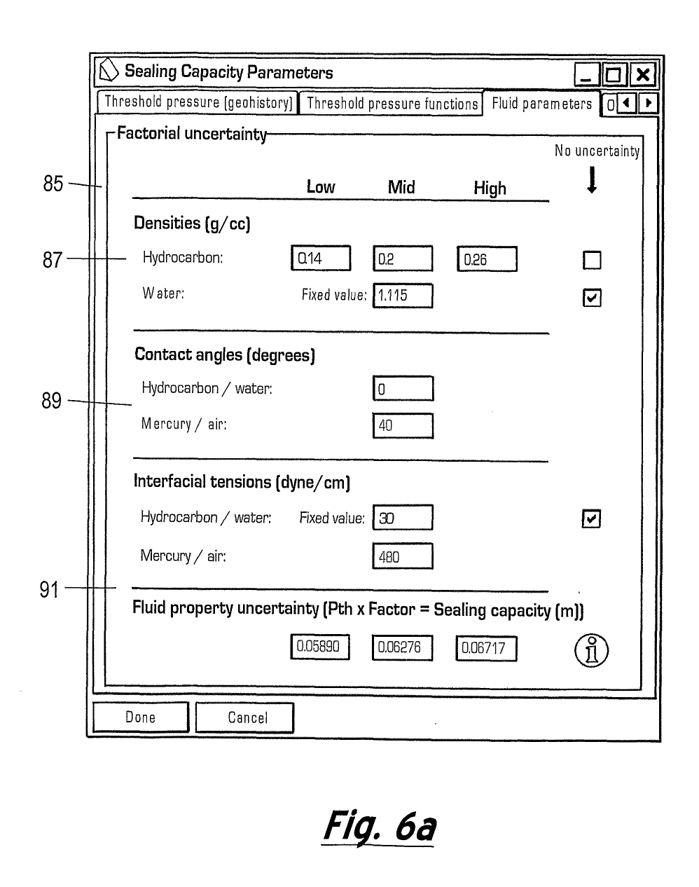

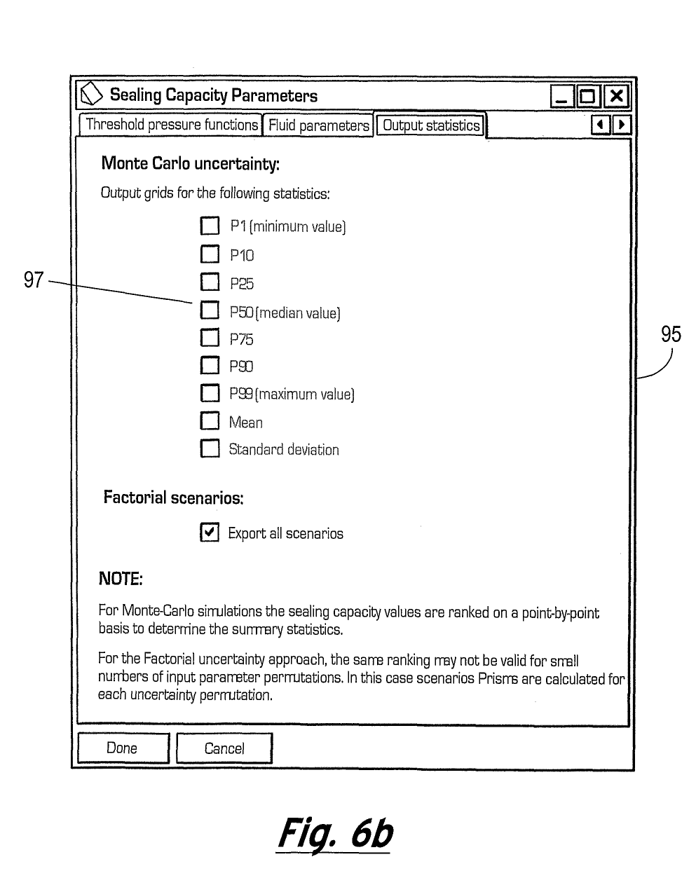

Sealing capacity values are calculated in order to provide a range of results. This approach allows for the inclusion of uncertainties in the sealing capacity values. Two approaches are used, a parametric approach as shown in FIG. 6a and the statistical approach is shown as FIG. 6b. In the parametric approach, a number of values and physical variables are selected. The GUI allows the user to select low, medium and high values for hydrocarbon density 87 and water density. The contact angle 89 for hydrocarbon/water can be set. Low, medium and high values of the interfacial tension 91 for hydrocarbon/water can be selected. The contact angle 89 and interfacial tension 91 for mercury/air are fixed. A factor is calculated which relates to the uncertainty in the fluid property which when combined with the threshold pressure gives the sealing capacity.

In this example, the statistical technique that is used is Monte Carlo simulation in which random sampling of the data is used to provide a range of outputs. FIG. 6b shows the GUI in which the user is able to select a number of statistical outputs. The creation of a number of different scenarios in which variations in sealing capacity occurs allows the user a significant degree of freedom when selecting different sealing capacity data volumes to be mapped onto the hanging wall and foot wall fault planer property maps. Once the data volumes have been created, the data is used to populate a map of the fault with sealing capacity information from a scenario.

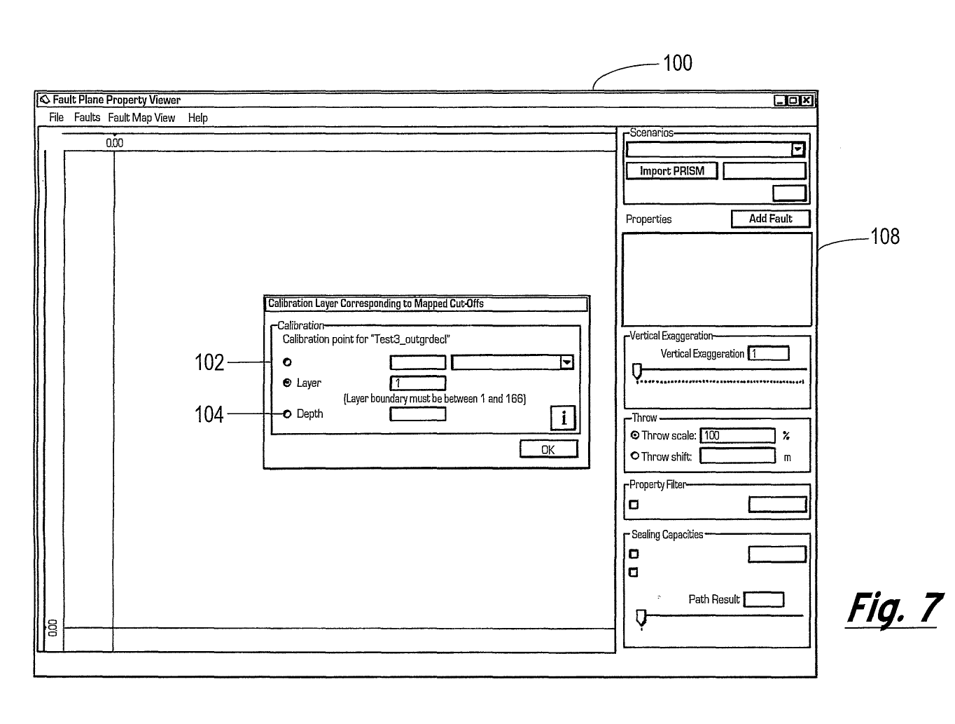

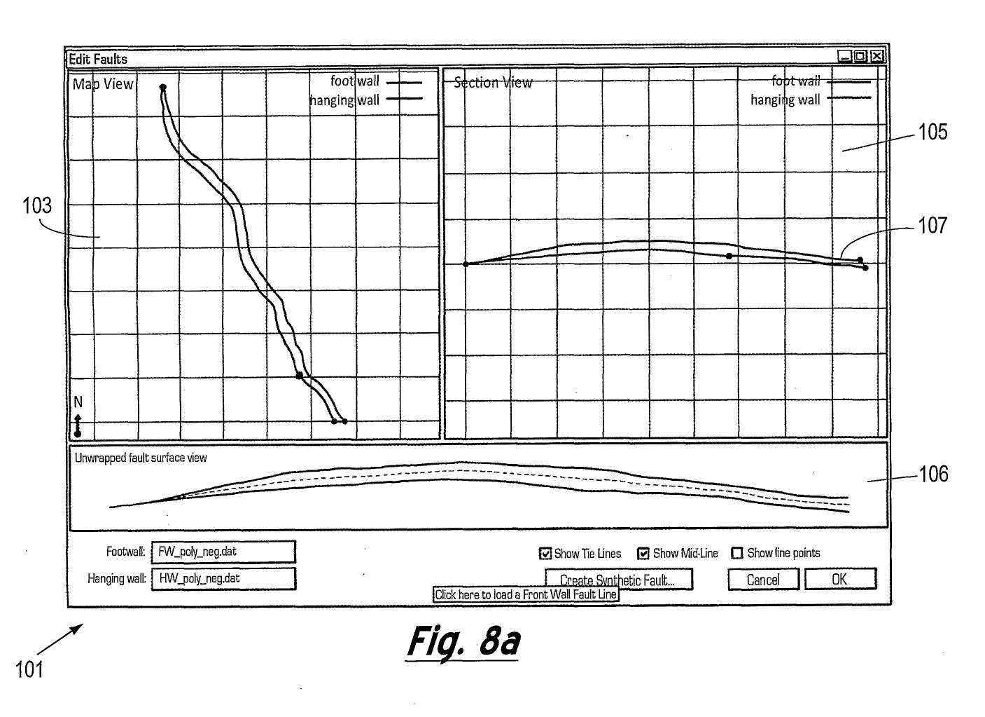

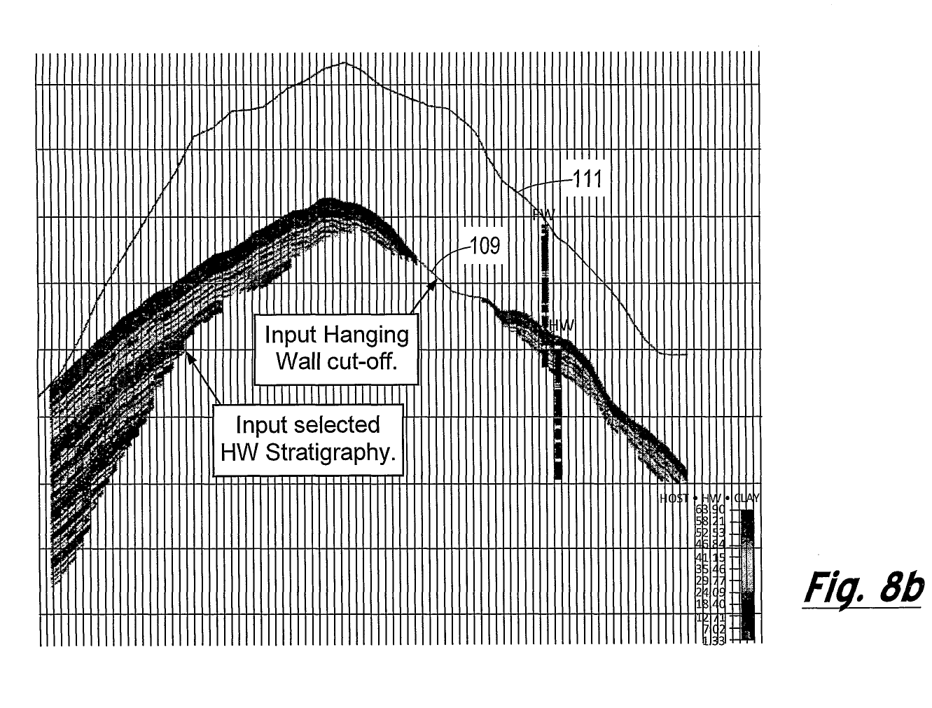

FIGS. 7, 8a and 8b show the calibration of FPPV and PRISM data. FIG. 7 shows a box 110 entitled “Calibration Layer Corresponding to Mapped Cut-Offs” which contains inputs for the layer and depth. Side bar 108 provides an input where the user can vary the vertical exaggeration, throw, and sealing capacity. A property filter is also included. The FPPV reads in data related to the FW and HW cut-offs plus PRISM data. These two data types are correlated by determining the locations in the PRISM data that correspond to the FW cut-off. The user defines either a specific depth or a specific PRISM grid layer (layer number or defined PRISM surface) to match to the FW cut-off.

FIGS. 8a and 8b show a GUI 101 of the fault plane property viewer which comprises a map view 103, a section view 105 and a preview 106. The user inputs hanging wall and foot wall cut-off data then selects the required stratigraphy 107 or pastes all stratigraphies along the back panel. The fault property/scenario is then selected, fault throw is varied and an assessment is made of the sealing capacity. The output is a fault plane property map which allows the user to assess the fault and to determine flow paths through the fault from the modelling of sealing capacity, stratification and throw and to create a physical map of the fault using any of the data volumes which have been calculated.

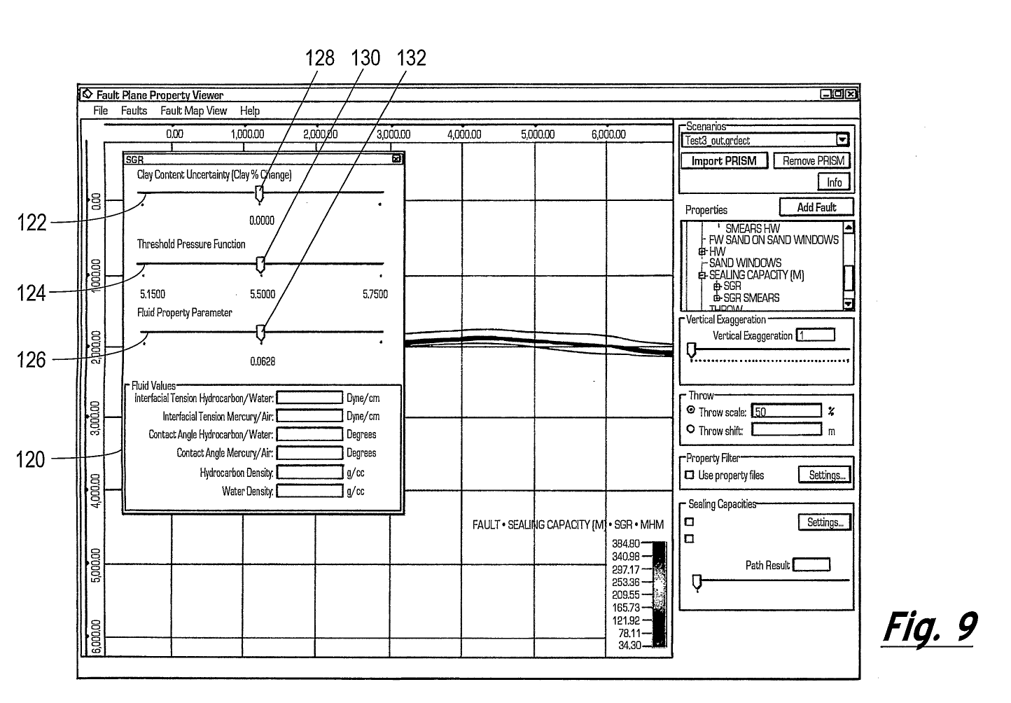

FIG. 9 shows a GUI 120 which allows variation in uncertainties in clay content 122, threshold pressure function 124 or fluid property parameters 126 (calculated in PRISM) by selecting these properties with sliders (128, 130, and 132). As the fluid property parameter is changed, the corresponding individual fluid properties are displayed.

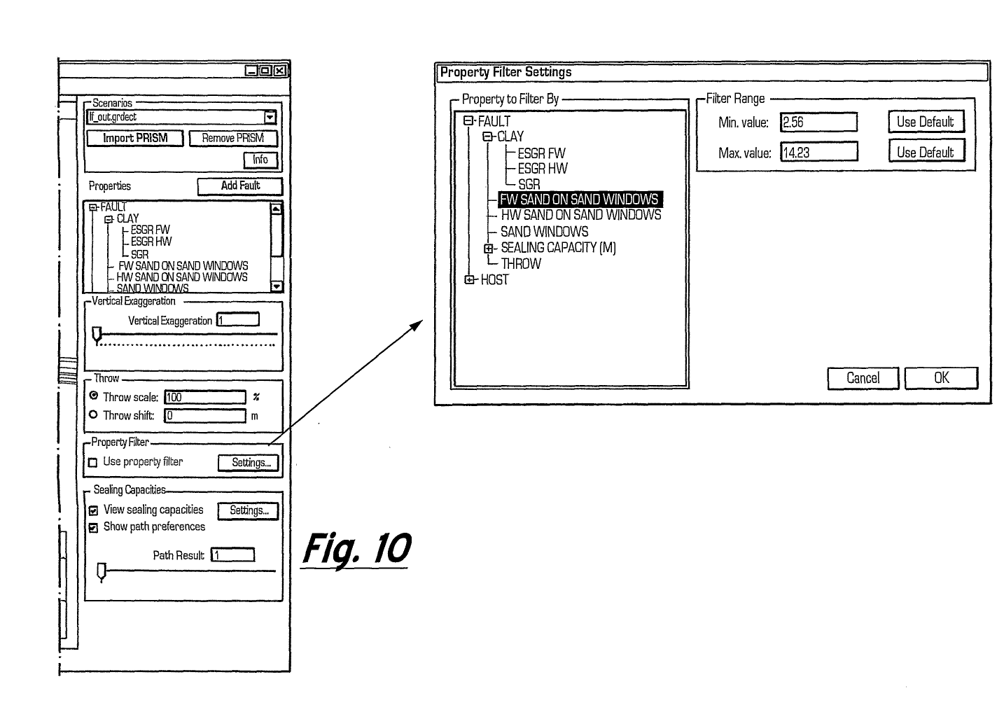

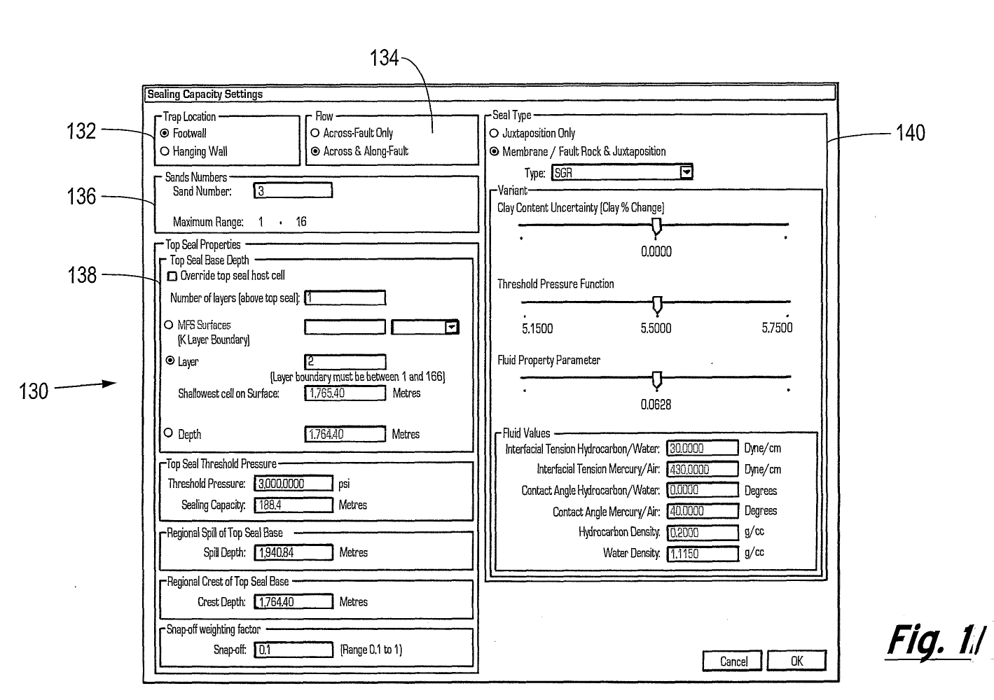

FIG. 10 shows the property filter which is able to refine the view of one property based on a reduced range of a second chosen property. E.g. show property X where property Y has values in a reduced range. The places on the fault plane where the condition is not met can be either removed or made transparent (variable transparency). For example, FIG. 11 shows the values of ESGR in the FW, filtered on the places where there are sand windows i.e. sand in both FW and HW.

The FPPV has a component that is able to predict the hydrocarbon column height for a specific fault, specific fault clay model, specific uncertainties, a specific sand unit, and a defined trap geometry (sand and top seal geometry near to the fault).

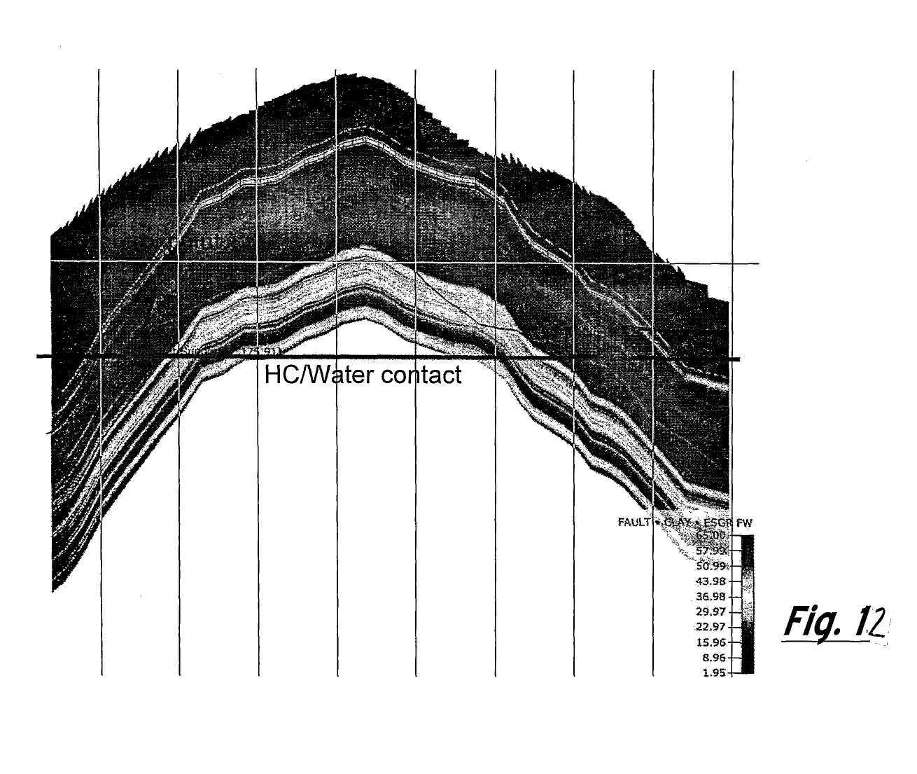

The algorithm then searches cells on the fault plane based upon the sealing capacity search criteria 130 shown in FIG. 12. These criteria include trap location 132, Flow 134, Sands Number 136, top seal properties 138 and Seal type 140. The result is a particular hydrocarbon column height, and the properties that control the hydrocarbon accumulation (e.g. top seal control, fault control).

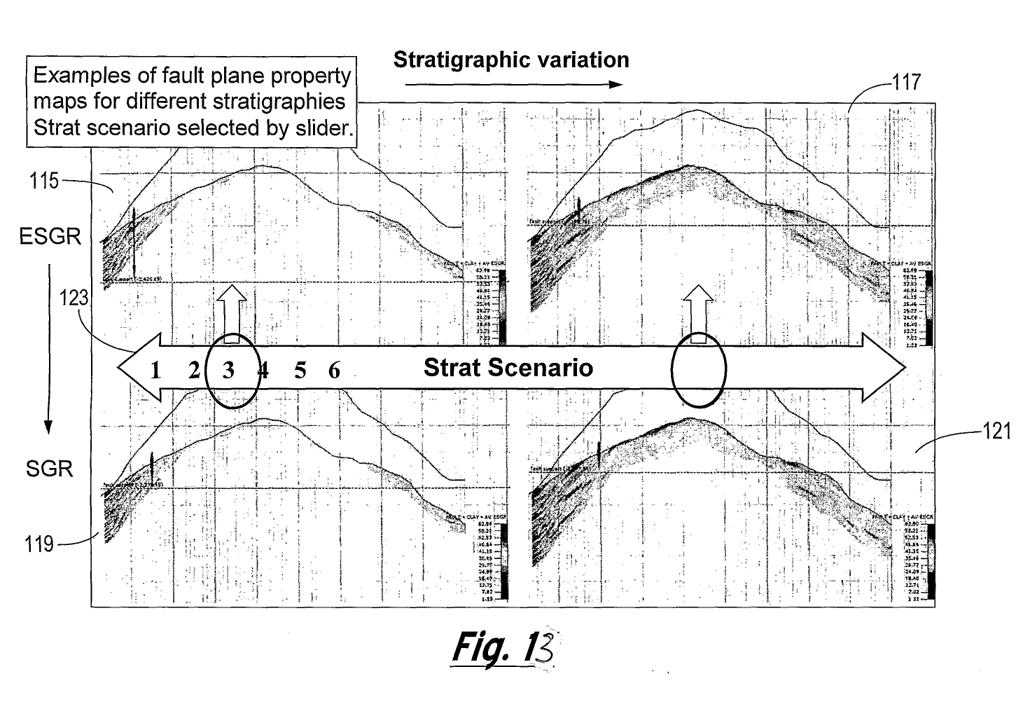

Additionally the FPPV is able to track the search path that has been followed as shown in FIG. 13 by the black line.

The system is adapted to analyse each data volume such that the points on the stratigraphy map are identified and the data volumes interrogated to identify fault rock clay and sealing capacity data that corresponds to a physical location on the fault.

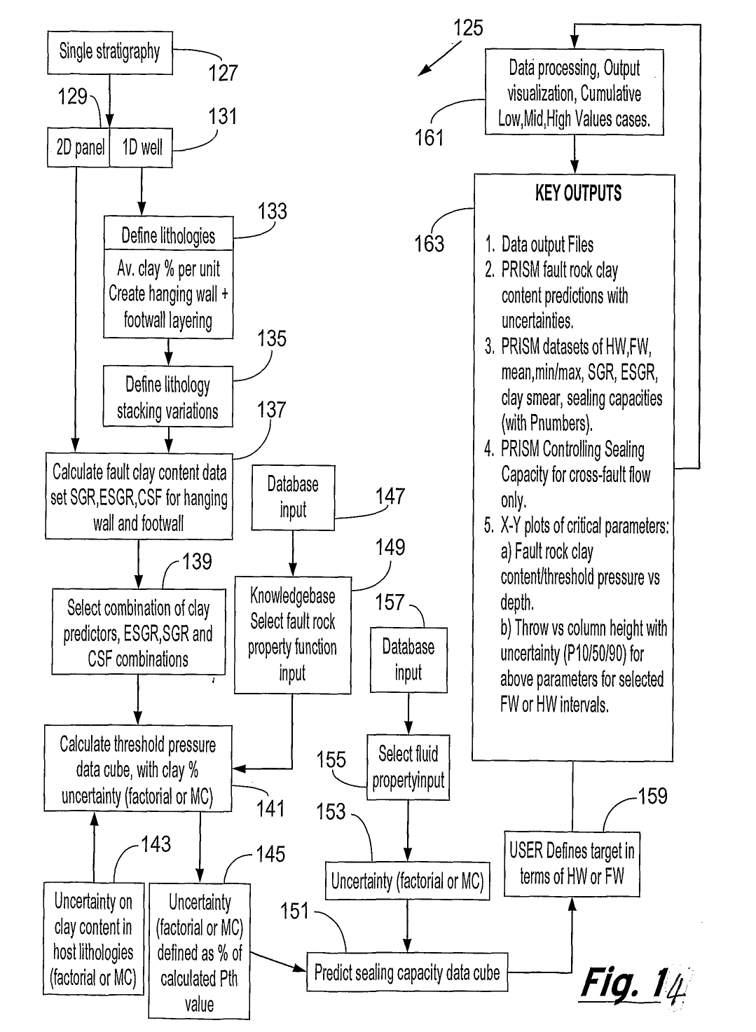

FIG. 14 shows a further figure of an embodiment. The GUI presents four possible stratigraphy maps which have been calculated using different calculated/modelled stratigraphic scenarios (data volumes) 115, 117, 119 and 121. Slider 123 allows the user to select and view different stratigraphic scenarios.

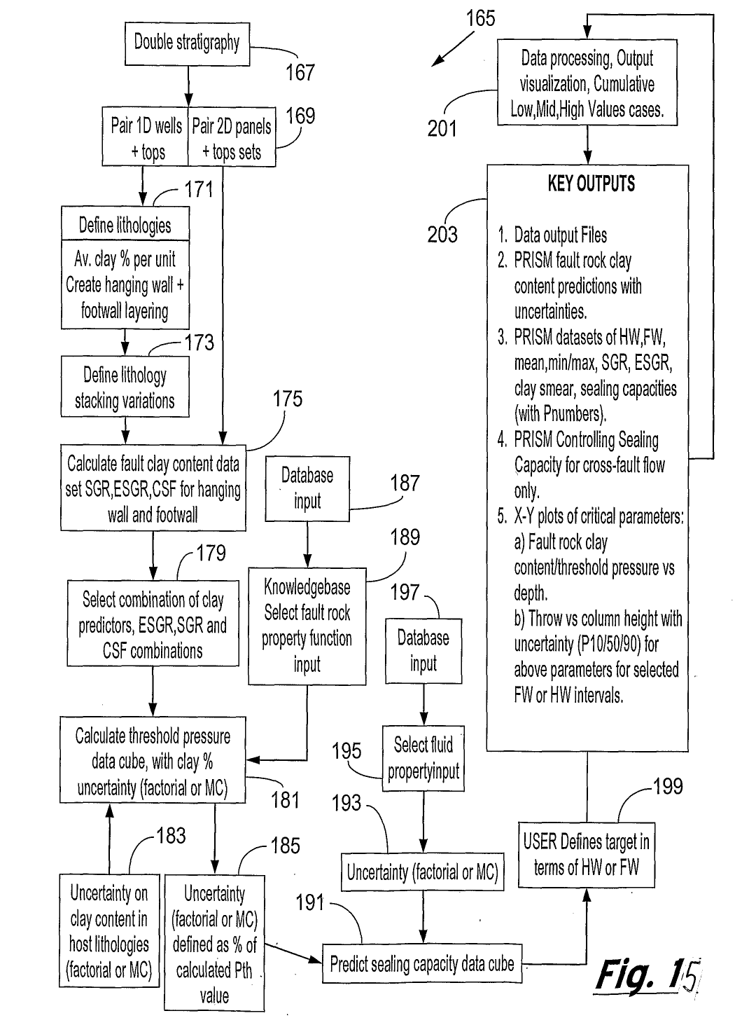

The diagram of FIG. 15 illustrates one embodiment 125 in which a single stratigraphy 127 is required and provided as either two-dimensional panel data 129 or one-dimensional well data 131. In the case of the one-dimensional well data 131 additional calculations 133 and 135 are made which define the lithology in terms of its clay content and its stratigraphic variations.

Thereafter SGR, ESGR and clay smearing are calculated and combined together 139. The threshold pressure data cube is calculated with a clay percentage uncertainty 141. This calculation is made using information on clay content uncertainty 143 and data relating to the threshold pressure and geohistory of the field and of other similar fields.

An uncertainty is applied to the output of calculation 141 by making choices from a set of possible threshold pressure curves and this is used to predict the sealing capacity data cube 151 along with other input data such as fluid properties 155 and physical or statistical uncertainties 153. These calculations provide a data volume which is to be investigated by the fault plane property viewer in order to produce a graphical representation of the data.

Thereafter the user defines the target reservoir units in terms of the hanging wall or foot wall 159 and the fault plane property viewer processes the data to provide a graphical representation or map in which the sealing capacity of the fault is shown.

Reference 163 identifies a number of key outputs namely:

the fault rock clay content prediction includes uncertainties; datasets for hanging wall and foot wall mean mean/min/max, SGR/ESGR clay smear and sealing capacities are used; and
data provided for controlling sealing capacity calculation in the fault plane property viewer for cross-fault and along-fault flow.

FIG. 16 is a flow diagram 165 which is similar to flow diagram 125 but which uses a double stratigraphy 167 as input data.

In another embodiment, control means are provided for adapting an input such as fluid injection to a well in response to the sealing properties of the fault as shown on the diagram. The control means may operate automatically in response to data which provides the basis for the displayed diagram.

The system is designed to allow a user to include variations in a large number of input parameters to deal with uncertainties in these values. The input parameters include:

Stratigraphic realisations (multiple well data inputs, back panel and input from gOcad);

Prediction of threshold pressure from fault rock clay content via RDR knowledgebase;

Uncertainty in clay mixing algorithm (SGR, ESGR)

Low/mid/high shifts, e.g. −10%, 0%, 10% clay content shifts;

Uncertainty in clay smear prediction;

Low/med/high shifts, e.g. −5%, 0%, 5% clay content shifts;

Uncertainty in fault rock clay content to threshold pressure prediction (uncertainty on knowledgebase curves;

Fluid parameters for prediction of sealing capacity from threshold pressure;

Hydrocarbon and water densities Low/mid/high values;

Hydrocarbon/water contact angle Low/mid/high shifts; and

Hydrocarbon/water interfacial tensions Low/mid/high shifts.

The factorial approach can be taken in dealing with these uncertainties (all combinations of low/mid/high between parameters). A further advantage is that the user interface is set up to enable some uncertainties to be completely ‘turned off’.

Improvements and modifications may be incorporated herein without deviating from the scope of invention.

1. A fault seal analysis system comprising:
data input means adapted to receive data pertaining to one or more physical parameters of a rock stratigraphy at or near a fault;
analysis means adapted to
I. apply one or more algorithms to create a model of the geometry and physical properties of the rock at or near the fault, the analysis means further comprising a user input which allows a user to vary input parameters of the one or more algorithms; and
II. create one or more data volumes or models of the geometric and physical parameters; and
a fault plane property viewer (FPPV) having at least one fault property diagram of a fault and a software module adapted to interrogate the data volume to map data from the data volume onto the diagram to show the sealing properties of the fault.

2. A fault seal analysis system as claimed in claim 1, the system further comprising control means for adapting input data to view the response to the sealing properties of the fault as shown on the fault property diagram.

3. A fault seal analysis system as claimed in claim 1, wherein the FPPV is further adapted to allow the user to select from a plurality of data volumes.

4. A fault seal analysis system as claimed in claim 1, wherein a fault surface a stratigraphy model can be selected for a given fault, for a known depth and throw variation and each data volume that is generated is designed to capture a range of uncertainties in the different parameters and allow the user to interrogate these using a fault property diagram.

5. A fault seal analysis system as claimed in claim 3, wherein the selection is made on a graphical user interface (GUI).

6. A fault seal analysis system as claimed in claim 5, wherein the selection is made by representing each data volume graphically and allowing the user to move between the graphical representations.

7. A fault seal analysis system as claimed in claim 1, wherein the data input means receives well data.

8. A fault seal analysis system as claimed in claim 7 wherein the data received at data input means comprises 1 dimensional well data or two dimensional panel data.

9. A fault seal analysis system as claimed in claim 8, wherein the panel comprises data comprising a pre-defined lateral variation in well data.

10. A fault seal analysis system as claimed in claim 7, wherein the input data comprises well log data.

11. A fault seal analysis system as claimed in claim 7, wherein the input data comprises data which identifies the reservoir units, top seal and trap geometry.

12. A fault seal analysis system as claimed in claim 2, wherein a first algorithm is applied to model stratigraphic variation based upon the input data.

13. A fault seal analysis system as claimed in claim 12, wherein a second algorithm is applied to create one or more pseudo wells based upon input well data.

14. A fault seal analysis system as claimed in claim 1, wherein the system further comprises a fault rock clay mixing calculation.

15. A fault seal analysis system as claimed in claim 14, wherein the clay mixing calculation comprises a combination of one or more of shale gouge ratio (SGR), effective shale gouge ratio (ESGR) in foot wall (FW) and ESGR in hanging wall (HW).

16. A fault seal analysis system as claimed in claim 1, further comprising means for calculating a clay smear.

17. A fault seal analysis system as claimed in claim 12, wherein a third algorithm calculates sealing capacity parameters.

18. A fault seal analysis system as claimed in claim 17, wherein the sealing capacity parameters are calculated by using data related to threshold pressure, a threshold pressure function, fluid parameters and output statistics.

19. A fault seal analysis system as claimed in claim 17, wherein the sealing capacity parameters are calculated by applying a predictive function that is based on the known variations in threshold pressure as a function of clay content.

20. A fault seal analysis system as claimed in claim 19, wherein the known values are derived from historical data which describes changes in the physical conditions that the rock has experienced.

21. A fault seal analysis system as claimed in claim 20, wherein the historical data relates to geohistory information, categorisation of rock evolution, range of temperature, temperature during faulting and pressure history.

22. A fault seal analysis system as claimed in claim 20, wherein the historical data can be presented as a series of curves of threshold pressure as a function of clay content.

23. A fault seal analysis system as claimed in claimed in claim 17, wherein the sealing capacity parameters are calculated by calculating the match between user defined parameters and the known historical data.

24. A fault seal analysis system as claimed in claim 23, wherein the degree of matching is presented graphically.

25. A fault seal analysis system as claimed in claim 20, wherein the user can select historical data that is not the best match.

26. A fault seal analysis system as claimed in claim 17, wherein sealing capacity values are calculated from the sealing capacity parameters in order to provide a range of results.

27. A fault seal analysis system as claimed in claim 1, further comprising control means for adapting an input to a well in response to the sealing properties of the fault as shown on the diagram.

28. A computer program comprising program instructions for implementing a fault seal analysis system comprising:
data input means adapted to receive data pertaining to one or more physical parameters of a rock stratigraphy at or near a fault;
analysis means adapted to
I. apply one or more algorithms to create a model of the geometry and physical properties of the rock at or near the fault, the analysis means further comprising a user input which allows a user to vary input parameters of the one or more algorithms; and
II. create one or more data volumes or models of the geometric and physical parameters; and
a fault plane property viewer (FPPV) having at least one fault property diagram of a fault and a software module adapted to interrogate the data volume to map data from the data volume onto the diagram to show the sealing properties of the fault.
